(19) United States
(12) Patent Application Publication
(10) Pub. No.: US 2004/0005044 A1
(43) Pub. Date: Jan. 8, 2004

(54) System for integration of multi-function and information service and electronic apparatus for the same

(76) Inventor: I-Hau Yeh, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/612,939

(22) Filed: Jul. 7, 2003

(30) Foreign Application Priority Data
Jul. 5, 2002 (TW) 091115120

(51) Int. Cl. H04M 1/56; H04M 15/06

(52) U.S. Cl. 379/142.01; 379/142.07; 379/142.16

(57) ABSTRACT

In a system for integration of multi-function and information service, an electronic apparatus is connected to a teletelephone line for a user to edit message or instruction to transmit to the electronic apparatus through the teletelephone line. The electronic apparatus demodulates/decodes the received signal and then transfers it to its destination for remote control of intelligent appliance, delivery of message, placement of e-advertisement and various functions. In an embodiment, TV set is used as a data output medium for the electronic apparatus to output the received data in a video and/or audio format. In another embodiment, the electronic apparatus is integrated into a TV set to provide multi-function and information service in addition to entertainment function.

### FIELD OF THE INVENTION

The present invention relates generally to an information transmission system, and more particularly to a system for integration of multi-function and information service.

### BACKGROUND OF THE INVENTION

Putting caller identification (CID) on display may allow telephone-users to view the number of an incoming phone call before answering to it, which permits the telephone-users to screen phonecalls. Since CID chip technology is fairly mature now, the practice of phonecall screening is viable by hardware approach or software approach. The cost of making such said phonecall screening system is rather inexpensive.

Sending and receiving short message provides additional channel for communications. Besides its basic, conventional capabilities such as delivering simple text, short message service SMS), today, may even deliver animation and sound. Short messages may be transmitted by a number of electronic apparatus such as by computers or mobile telephones.

E-mail allows people to receive and read the content of the message sent from others in real time. As for majority of people, checking e-mail online has become a part of their daily occurrence, indispensably.

The modern household conveniences such as healthcare apparatus, security systems, and intelligent appliances (IAs) provide every convenience for the comfort of users. Modern high-tech emphasizes the added value and integration of different products' capabilities into one. Integration and added value render greater services and better functioning of products to users.

Capabilities and services of the modern household conveniences described above are often furnished and controlled by different systems from various providers. If these systems are able to be integrated all together into one single module, a versatile apparatus, as such, will definitely offer greater convenience to users.

### SUMMARY OF THE INVENTION

One object of the present invention is to provide an integrated versatile system with information services. Common household intelligent appliances (IAs) with the system may offer a total solution for the users.

The present invention is directed to an integrated system, which incorporates multi-function and information service of various electronic apparatus into one. An electronic apparatus in the system is connected to a teletelephone line. Users may transmit an edited message (such as a CID or short message) with any editer tools (such as a mobile telephone and Website) or give an instruction to the electronic apparatus through the teletelephone line. The electronic apparatus demodulates or decodes the received signal and then transfer the decoded signal to its destination based on the content of the signal. According to the present invention, capabilities, such as remote control of intelligent appliance, delivery of message, placement of e-advertisement and more, are perfectly possible of attainment and realization by the foregoing integrated system. In an embodiment of the present invention, television (TV) set, an everyday household appliance, is used as a data output medium, which allows the aforementioned electronic apparatus to picture or voice output of the received data. In another embodiment, the electronic apparatus is integrated into a TV set so that the most common household appliance, TV set, performs multi-function and provides information services in addition to entertainment.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 briefly illustrates the objective and characteristics of the present invention;;

FIG. 2 provides the preferred embodiment of the invention;

FIG. 3 illustrates a link between an electronic apparatus of the invention and a TV set; this link establishes a scheme for providing CID, EID, SMS, EMS, and E-mail;

FIG. 4 illustrates a structure for providing multiple information service; this structure is presented by the electronic apparatus in accordance with the invention;

FIG. 5 illustrates a structure for controlling intelligent appliance(s) and the corresponding information exchange system; these structure and system are presented by the electronic apparatus in accordance with the invention,;

FIG. 5A illustrates an embodiment for controlling the intelligent appliance(s) through a Website, and also for exchange of information;

FIG. 5B illustrates the course of generating instructions by the Website server shown in FIG. 5A;

FIG. 5C illustrates another embodiment for controlling the intelligent appliance(s) and exchanging information through a teletelephone line;

FIG. 6 illustrates a structure for a security system; this structure is presented by the electronic apparatus in accordance with the invention;

FIG. 7 illustrates a structure for a healthcare service system; this structure is presented by the electronic apparatus in accordance with the invention;

FIG. 8 illustrates a structure for emergency system, which is presented by the electronic apparatus in accordance with the invention;

FIG. 9 illustrates the integration of the electronic apparatus in accordance with the invention into a TV set; this integration enables a TV set to provide multi-functions and service for users besides entertainment;

FIG. 10 further illustrates the embodiment of the TV set shown in FIG. 9;

FIG. 11 illustrates the other embodiment of incorporating the electronic apparatus into a TV set in accordance with the invention; and

FIG. 12 illustrates another embodiment of incorporating the electronic apparatus in accordance with the invention into a TV set.

### DETAILED DESCRIPTION OF THE INVENTION

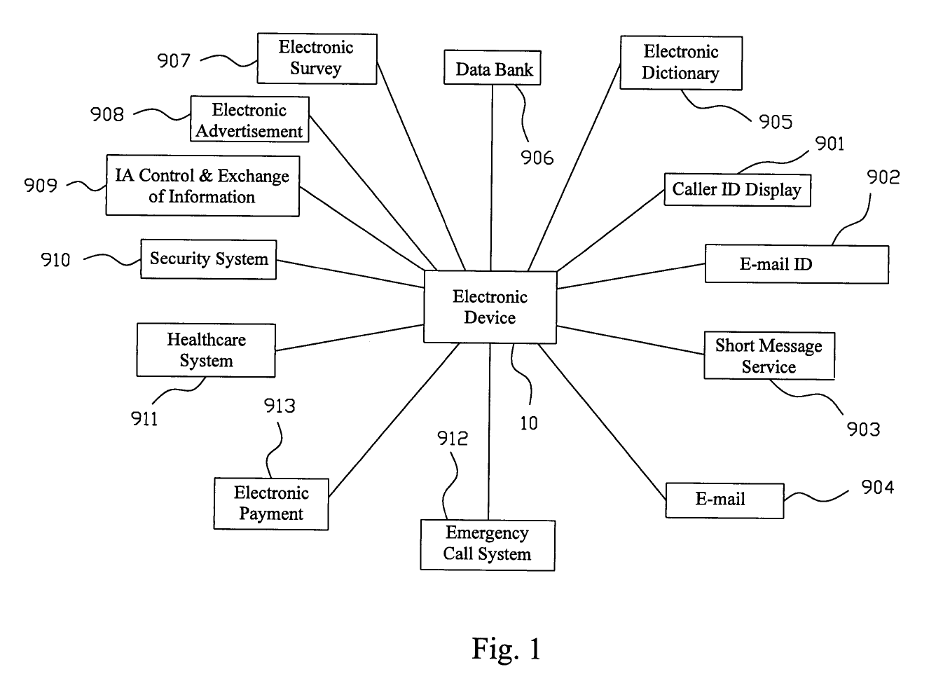

The objects of the present invention and features are illustrated in FIG. 1. An electronic apparatus 10, according to the present invention, may integrate multi-function and provide numerous capabilities. The electronic apparatus offers capabilities such as CID 901, email identification (EID) 902, SMS 903, E-mail 904, e-dictionary 905, data bank 906, e-survey 907, e-advertisement 908, intelligent appliance control and exchange of information 909, security system 910, healthcare apparatus 911, emergency call system 912, and even e-payment mechanismsp 913. The inventive system integrates all possible functions and capabilities of household appliances into one and thus allows users to operate and control household appliances with ease, and furthermore, allows for many more applications.

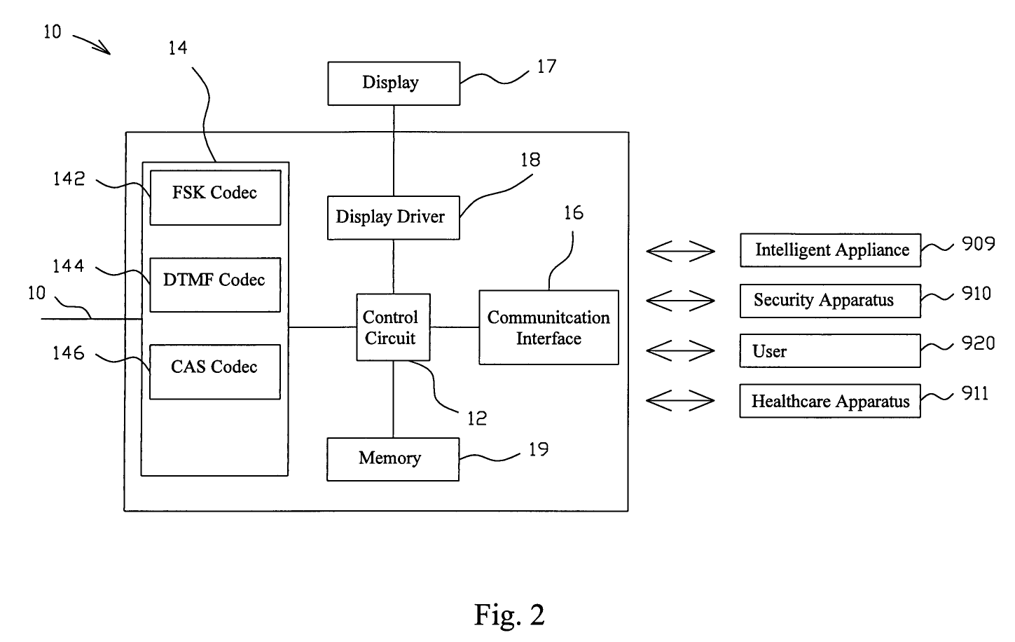

FIG. 2 introduces the scheme of the electronic apparatus 10 according to the present invention. The electronic apparatus 10 is connected to a telephone line 11. The electronic apparatus 10 has one assigned phone number. According to the preferred embodiment and the following description, the assigned phone number may be a set of phone number (for instance, 666666) or an extension (such as 666666-0001). The electronic apparatus 10 of the embodiment consists of a control circuit 12, which conducts the electronic apparatus's operation, and a decoder or codec (coder/decoder) 14 connected between the telephone line and the control circuit 12. The content of transmitted signal from the telephone line to the electronic apparatus 10 may be data or an instruction. The transmitted signal relates to a destination address according to the electronic apparatus's corresponding phone number or extension. A block 14 is with at least decoding capability to decode messages and provide information such as CID, SMS, EID, and the like. The block 14 contains an encoding circuit and allows the electronic apparatus 10 to send messages. Codec circuit 14 consists of various encoders and decoders, for example, an FSK codec 142, DTMF codec 144, and CAS codec 146. The choice of codec for the codec circuit 14 is determined by the type of the signal for each system and the signal transmitted by a telephone line as shown in FIG. 1. A communication interface 16, which allows the electronic apparatus 10 to have one-way or two-way interaction with outside, is connected to the circuit control 12. The electronic apparatus 10 communicates with outside by wired (such as power lines and telephone lines) or wireless (such as RF or IR) transmission media. The electronic apparatus 10 and communication system or apparatus require its own corresponding transmiter/receiver module based on the type of transmission medium selected. This is well known to the those skilled in communication industry; no further description will be provided herewith. Every capability of the electronic apparatus 10 shown in FIG. 1 may be realized by implementing one-way or two-way communication for a communication interface 16 with an intelligent appliance 909, security apparatus 910, healthcare apparatus 911, and users. The electronic apparatus 10 further includes a display driver 18, which is connected to the control circuit 12 to drive the display 17. In other embodiments, a display may be integrated into the electronic apparatus 10, just simularly to the current CID display in the market. Display such as cathod ray tube (CRT) display, liquid crystal display (LCD), light emitting diode (LED) display or plasma display panel (PDP) display may be provided by a TV set or computer. If a TV set is used for output display, the electronic apparatus 10 needs only to connect the output signal to the TV display module. In other embodiments, the electronic apparatus 10 includes an alert output apparatus (not shown) connected to the control circuit 12. When the electronic apparatus 10 receives a message (such as a CID, short message or EID), it will notify users by pre-recorded messages, sound of rings, music, flashes of light, characters or icons. The electronic apparatus 10 may also include a voice output apparatus, which is connected to the signal control circuit 12, and the voice output apparatus reads out incoming messages such as CIDs, short messages or EIDs. In other embodiments, an electronic apparatus 10 includes a memory 19 connected to the control circuit 12 to store word bank, dictionary, address book, calendar, financial information, and e-book and their related software, firmware programs, and application programs. Displaying the aforementioned information on a display to offer users e-dictionary and data bank services. For example, using TV set as a data output display to allow users to look up an unfamiliar foreign word from an e-dictionary preloaded in TV set while watching a TV program. A word-search input apparatus within a TV set may use a remote controller to integrate message editor module (for instance, an editor apparatus used in a mobile telephone), personal digital assistant (PDA), and handwritten input apparatus (for instance, a handwritten recognition system), and then it will send out messages entered by users to the communication interface 16 inside the electronic apparatus 10.

The electronic apparatus 10 may be implemented with current CID chip, including the chip with software decoding approach to offer CID function. Currently, CID chips are only applied to caller ID apparatus to show CID on a small LCD screen as well as for call waiting function. Showing CID on a small LCD screen may be somewhat inconvenient for people. For example, a household often comprises several family members and these members are not always happened to be next to the telephone. Besides, when a telephone rings, one must go to the telephone and look at incoming CID shown on the display screen. However, the incoming call may not be for the one who goes to check CID information on the screen and this person may not be able to recognize the unfamiliar incoming call; thus, he/she does not know to tell whom to come to answer the telephone. Obviously, a conventional CID display may not be the best apparatus to fulfill users' need. In one of the embodiments of the present invention, an electronic CID apparatus 10 may be integrated into a TV set (details will be elaborated later). After all, a household spends most of their recreation time for watching TV. Thus, integrating an electronic apparatus 10 into a TV allows a CID to show on the TV screen; this allows anyone in front of the TV set to see and respond to the call. Apparently, the present invention is more convenient and more efficient than conventional skills have been practiced. The present invention avoids wasting time and missing calls. In addition, more applications may thus applied and derived from it. For instance, an automatic CID notifying service (details will be elaborated later) introduced by the present invention relates to an e-mail server, which shows up an EID information on the TV screen through a telephone line right after receiving an e-mail. The EID information includes addressee's name, title, mailing time, and so on. Therefore, the addressee of the corresponding incoming e-mail may immediately be notified. Service as described allows the user of the invention to be updated on the most current information. According to the invention, more capabilities and functions may be performed by employing the electronic apparatus 10; however, no one has yet submitted or filed any similar to or same idea as the invention discloses here.

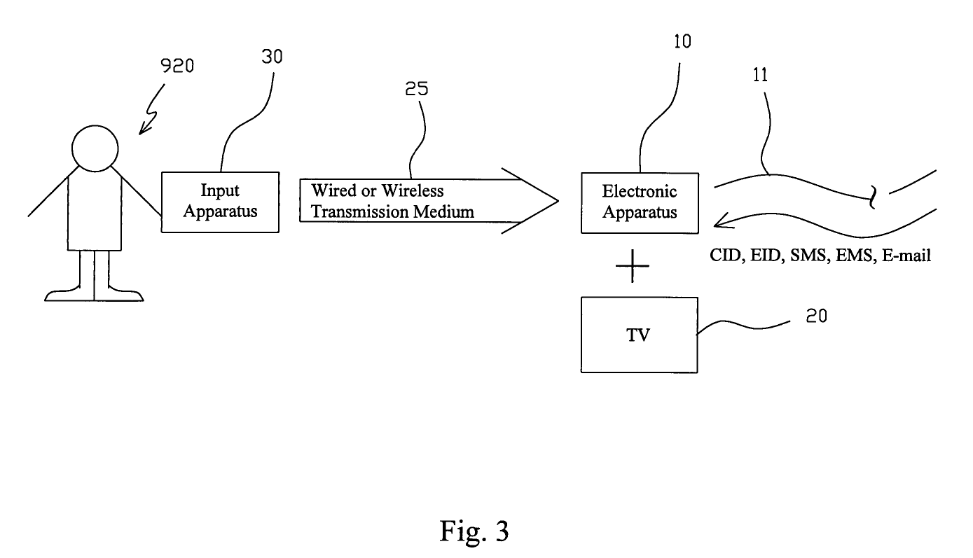

FIG. 3 illustrates the electronic apparatus 10 based on the present invention. The electronic apparatus 10 is connected to a TV set 20 to provide users CID information, SMS, and EID information shown on TV screen. As previously stated, the electronic apparatus 10 comprises codec (such as an FSK codec and/or DTMF codec); thus, the electronic apparatus may receive and decode transmitted data from a telephone line. A TV set 20 is used for an output display interface to support CID display capability. The electronic apparatus 10 provides and supports popular SMS. Operation of SMS may be conducted by a transmission medium (through a wired or wireless network); short messages may be sent to the users and picked up by the electronic apparatus through the telephone line 11. Once the short messages are being decoded (by the electronic apparatus 10), they will be displayed on TV screen 20. The electronic apparatus 10 also includes a notifying capability; it may notify users when their e-mail has been newly arrived. The aforementioned mail notifying technique is carried out by an e-mail server, which automatically retrieves EID information and sends the retrieved information to users' predetermined terminals. According to the embodiment, users use their telephone numbers as the addresses of the destination for EID. EID (as previously described) may include such as the name of the addressee, the name of the sender, mailing time, title and so on. Users may have some ideas about the incoming e-mail, and then they will decide if they need to go online immediately to check their mail. Hence, without turning on computers, users may still be informed and updated with the arrival of their most current e-mail at any time. This automatic mail-notifying manner by server is completely different from the techniques being practiced; the conventional way is users must connect to the Internet all the time to see if any new mail comes in. Users may screen out any unwanted e-mail by setting some rules or parameters beforehand at server-side. Users may set up filter rules for accepting mail, for example, from some specific senders or with specific titles. The electronic apparatus 10 receives, decodes, and outputs the CID information to display on the TV screen 20. As described previously E-mail may, of course, be transmitted to the electronic apparatus 10 through a telephone line. The content of the mail will be displayed on the TV screen 20 after the messages are being decoded. The carrying-out of the aforementioned display of CIDs, short messages, EIDs and e-mail is may be by connecting the electronic apparatus 10 to the TV display module. Thus, the content of incoming messages may be displayed on some specified location or position on the TV screen 20 by running marquee or AV signal source (such as video 1 or video 2).

Two-way communication is attainable; first, users send messages to the electronic apparatus 10 through an input apparatus 30 by a wired or wireless transmission medium 25 and then the electronic apparatus 10 sends the messages out. The input apparatus 30 may employ an existing TV remote control to integrate a message editor module (such as editing tool used in a mobile telephone), mobile telephone, PDA, handwritten input apparatus (such as handwritten recognition system), and keyboard. When the electronic apparatus 10 receives a CID, short message, EID or e-mail, it notifies users by sounds or flashes. Users may read incoming messages by switching channel to AV mode or by reading running marquee on the side screen of TV set. Users may just stay where they are; all they need to do is to press the remote control button and they may read their messages in real time. Users may send out messages through the electronic apparatus 10 by the input apparatus 30 as well. The invention integrates all these message receive-and-sent capabilities. This is going to be revolutionary and it will change the way how users used to receive or send out their messages. Everything is going to be easier and more convenient. Everything a user needs to do is to move his/her fingertips.

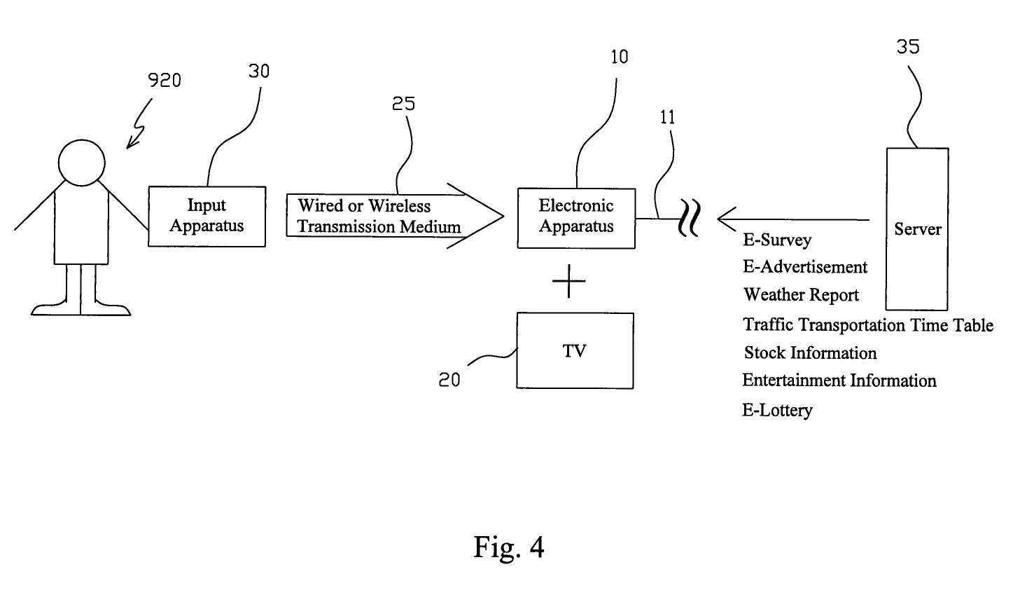

FIG. 4 illustrates how an electronic apparatus 10 is utilized to make multiple information service possible and the corresponding system and structure. As indicated in the diagram, the present invention may provide many useful information through a telephone line; these information may include weather report, timetable (for public transportation), stock, entertainment, finance and banking, e-lottery, e-survey, e-advertisement or any similar business mechanisms. Here we use TV set as a display interface; however, in other preferred embodiments, a computer or display may serve the purpose as well. In the diagram, a server 35 provides the aforementioned information such as weather report, timetable, stock, e-lottery, e-survey, and e-advertisement. The information is transmitted to the electronic apparatus 10 through the telephone line 11 and the electronic apparatus 10 displays these messages on the TV screen 20. Take TV rating survey as an example. A TV rating survey center (corresponds to a server) sends out e-survey to every household and this will display on the TV screen 20. Users may complete their surveys (on the program they are watching) by using a TV remote control (is equivalent to the input apparatus 30); the completed e-forms are then sent back to the survey center. In other embodiments, the aforementioned messaging services may be proceeded by short message server. That is, the server side contains a short message server/provider. Thus, short messages, e-survey, e-advertisement, e-lottery, weather report, timetable, and stock information may integrate altogether.

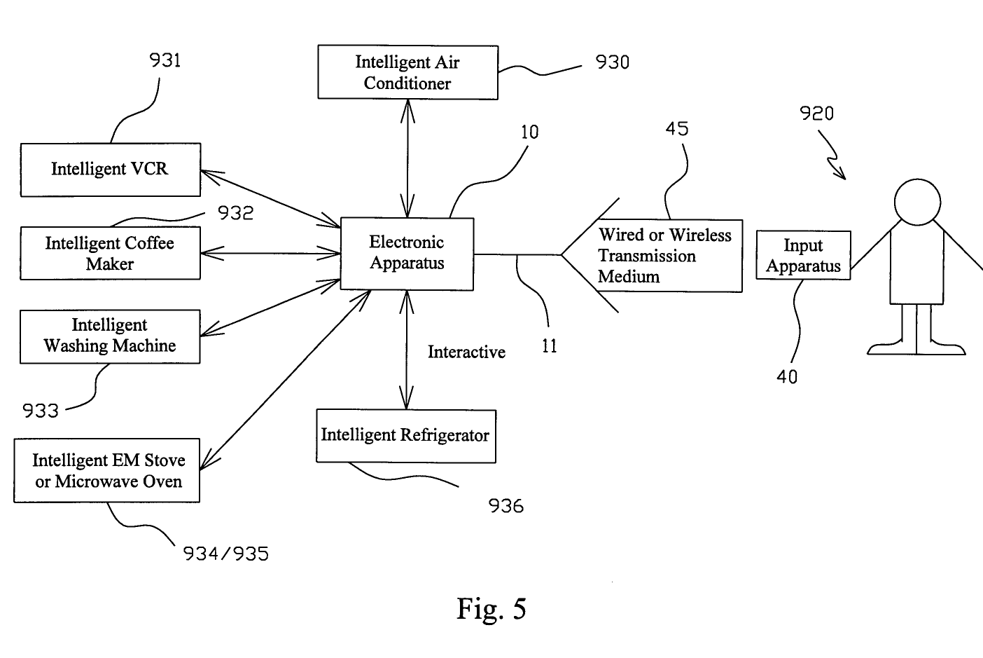

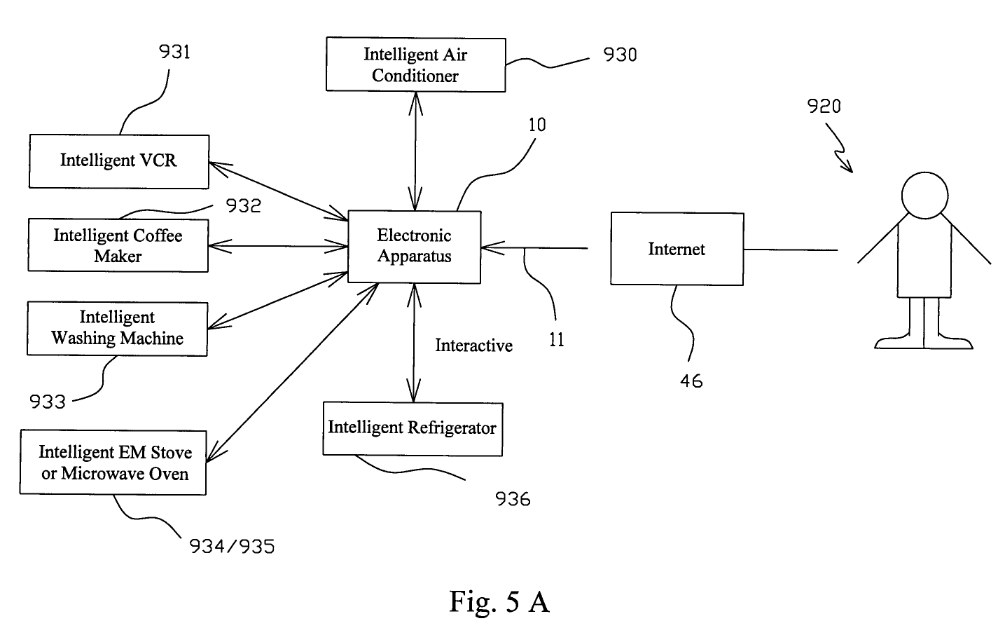

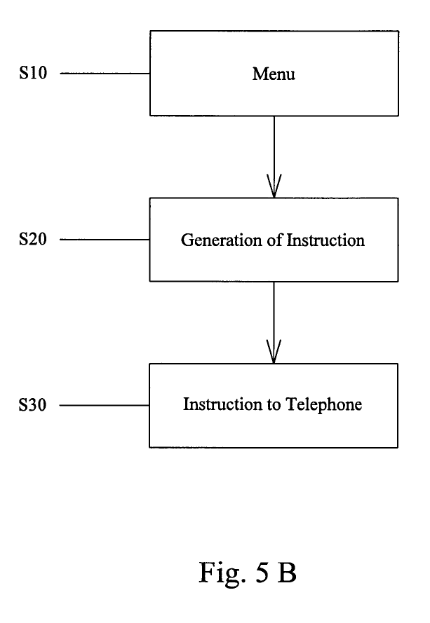

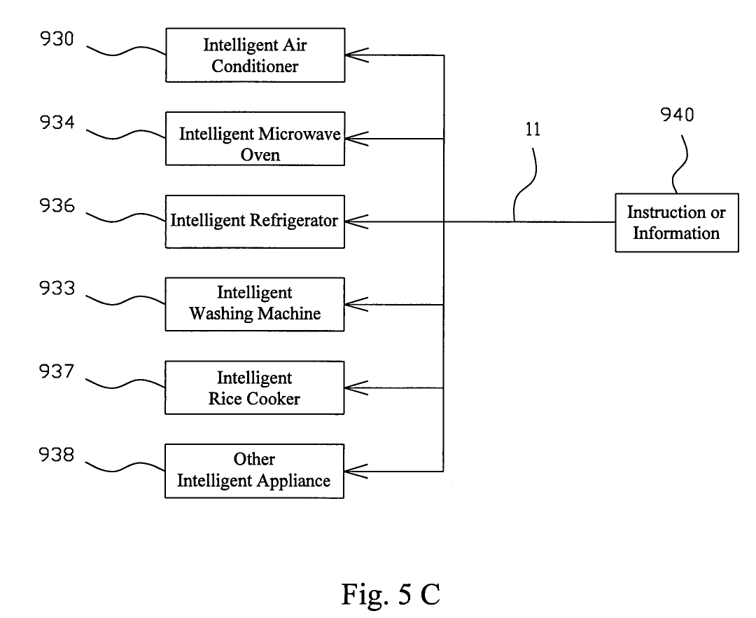

FIG. 5 illustrates a system structure that allows users to remotely control intelligent home appliances and to exchange information with them. The intelligent appliances as described here are able to accept external instructions and act upon them. When users are away from their intelligent appliances, regardless outdoor or indoor, they may give their instructions to a particular appliance through a household telephone line 11 by an input apparatus 40 through a wired or wireless communication medium 45 (including the Internet). The aforethe input apparatus 40, for example, may be a computer, PDA, handwritten input apparatus or mobile telephone. The electronic apparatus 10 sends the instruction(s) to the corresponding intelligent appliance(s), such as air-conditioner 930, VCR 931, coffee maker 932, washing machine 933, electromagnetic stove 934, microwave oven 935, refrigerator 936, VCD player, DVD player, or SVCD player, either through a wired transmission medium, such as a power line or teletelephone line, or a wireless transmission medium, such as RF or IR, to drive the particular appliance to work. Users may interact with their intelligent appliances through the electronic apparatus 10 as shown in other embodiments. For instance, users may check the content of their intelligent refrigerators 936 at home by sending a remote instruction request. If user wants to know how many eggs are still left inside their refrigerators, they just send a check instruction to their intelligent refrigerator(s) 936, and the result will be sent beck to the users through the electronic apparatus 10. This example illustrates a human-and-intelligent-appliance interaction as to make two-way communication. The structure as described in FIG. 5 may also work with E-commerce. Take the previous case as an example. When the number of eggs left in the refrigerator is below users' default setting/value, the intelligent refrigerator will notify the electronic apparatus 10 to inform their food/grocery suppliers for replenishment.

FIG. 5A offers another embodiment. The diagrams illustrates users 920 remotely control their home intelligent appliances through a Website 46. The Website 46 provides not only supplier information (on intelligent appliances for users), but also offers assistance in selecting an appliance. Furthermore, this Website allows user to control their appliances from a remote location. FIG. 5B illustrates the control operation and procedure of intelligent appliances from a server at the Website 46. In Step S10, the Website sever provides a selection menu for users; users may select a desired appliance and capability to give a instruction. Next, the server will generate a instruction which is based on the result of input information entered by a user. For instance, a request for checking the quantities of existing eggs inside the refrigerator; that is, Step S20. In Step S30, the server sends the instruction to the corcommunication terminal of the telephone number of default setting by the user. In one of the preferred embodiments of the invention, every family needs only one set of phone number. However, each intelligent home appliance has its own extension number or code. This means each code has been preprogrammed. The code will be sent to the electronic apparatus 10 and be decoded there. The decoded code will be sent to the address of the destination of the corresponding appliance. Both servers (of intelligent appliance control and EID processing) may integrate altogether; and the address of the destination for both servers are based on the default phone number programmed by the users.

FIG. 5C is another preferred embodiment that illustrates communication and control of intelligent appliances by a user through a telephone line. Each block shown in the diagram represents an intelligent appliance, for instance, an air conditioner 940, microwave oven 934, refrigerator 936, washing machine 933, or electric rice cooker 947. The control instruction 940 is sent to its corresponding intelligent appliance through a telephone line 11. Each of these appliances contains the aforementioned electronic apparatus 10, which is able to decode a instruction 940 entered by a user through a telephone line 11, and the intelligent appliance will act upon the instruction 940. Each intelligent appliance has its own corresponding phone number (or an extension or code). Today, call waiting technology has come to maturity. With this mature technology the electronic apparatus 10 is able to communicate with outside through the telephone line 11 without any interference or interruption. Communication and control of an intelligent appliance may continue.

Have each electronic apparatus 10 (of an intelligent appliance) included an encoder, which transmits an encoded signal to a remote terminal through a telephone line. This will establish an interaction and two-way communication between a user and an intelligent appliance.

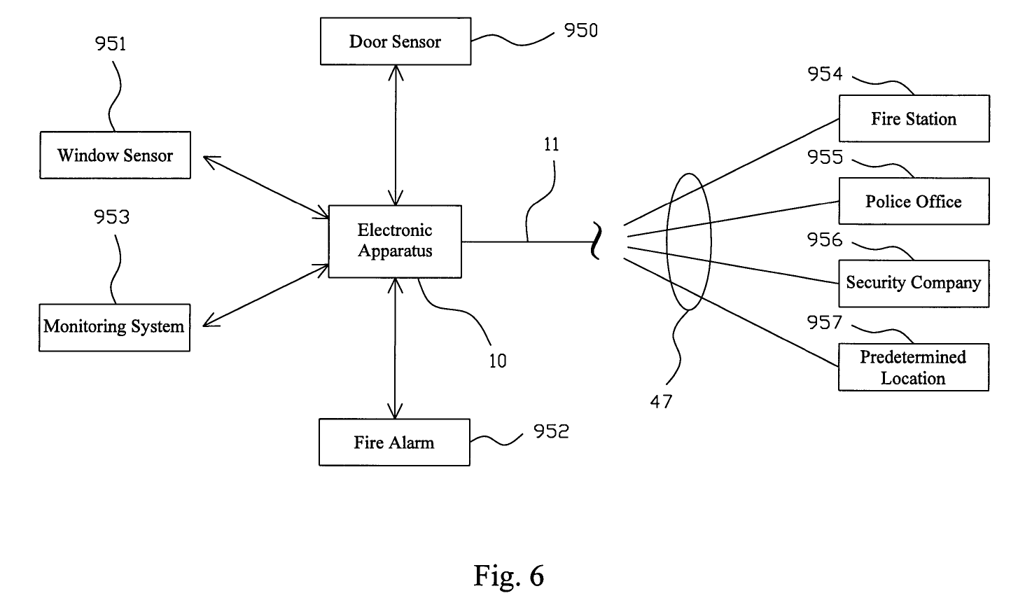

FIG. 6 illustrates a system structure for a security system. In case of emergency, such security system will be activated and instantly notify a destined terminal that a user has preprogrammed. A conventional security system is a stand-alone system and it connects to monitoring terminals such as a security company or police office. According to the structure as shown, the security system comprises an electronic apparatus 10, alarm system, monitoring apparatus, and a user's preprogrammed notifying terminal(s). An alarm system includes a sensor 950/951, fire alarm 952, and monitoring system 953. In order for a security system to properly function, the alarm system must work or communicate with the electronic apparatus 10, and the electronic apparatus will communicate some user's predetermined terminals through a telephone line 11 by a wired or wireless communication medium. These predetermined terminals may be a fire department 954, police office 955, security company 956, a place where a user stays or locations where a user has preprogrammed. Inside the electronic apparatus 10 must include a signal format converter, which enables the security apparatus to convert signals sent out by the security apparatus into an acceptable signal format to travel on a telephone line 11. If the security apparatus and the electronic apparatus 10 are connected, then the internal structure of the electronic apparatus 10 looks similar to the structure shown in FIG. 2. In case of emergency, such as a burglary or fire, the aforementioned security apparatus(s) will send out the alarm signals to the electronic apparatus 10, and the electronic apparatus will notify any relevant units to handle the situation and to have an immediate control over it. A security apparatus may connect to an electronic apparatus 10 by a wired transmission medium (such as a power line or a teletelephone line) or a wireless transmission medium (such as RF or IR).

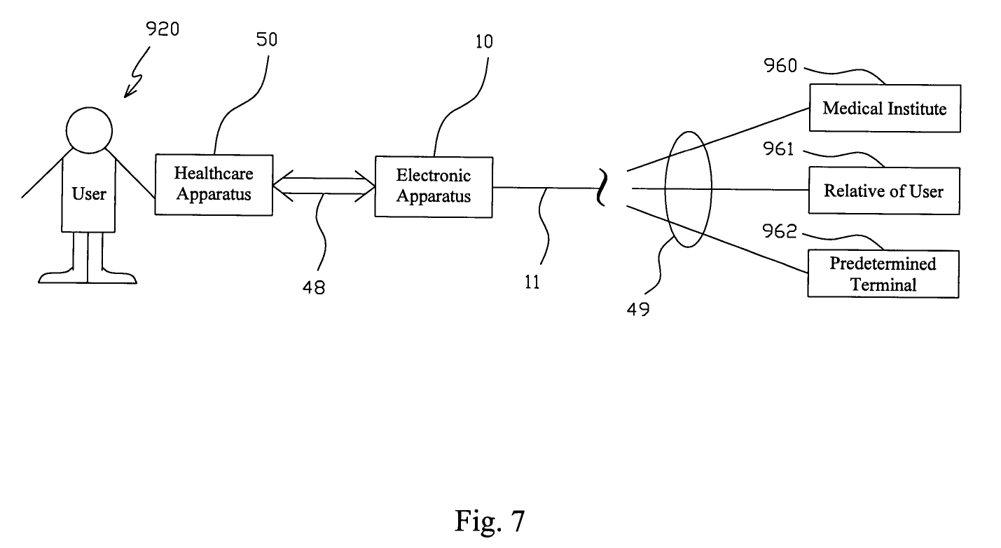

FIG. 7 illustrates the system structure for a healthcare service system, which improves health and care of the user. As shown in the diagram, a user 920 communicates with the electronic apparatus 10 through a healthcare apparatus 50 by a wired or wireless transmission medium 48. The transmission medium may include RF, IR, a power line, teletelephone line, or signal transmission line. The healthcare apparatus 10 will send out health information regarding the user 920 to the electronic apparatus 10, and then the electronic apparatus will pass the information to the predetermined terminal(s) set up by the user 920. These terminals may be a medical institute 960 nearby, family doctor or relative of the user 960 or other terminals 962. The medical institute 960 may also pass some medical information back to the user by the same path 49, and the electronic apparatus 10 will transfer the information and display it on a display, such as the aforementioned TV set, computer, portable electronic apparatus, and the like. The healthcare apparatus 50 may include a sphygmomanometer, heart-rate measuring apparatus, glucometer, heart diagnostic apparatus or other health test apparatus. Inside the electronic apparatus must equip with a signal format converter to convert signal(s) sent out by the healthcare apparatus 50 into acceptable signal format that may travel through on a telephone line 11. If the healthcare apparatus 50 is connected to the electronic apparatus 10, the internal structure of the electronic apparatus looks similar to the one shown in FIG. 2. The medical institute 960 and friends and family (of a user) 961 will have more control over the health condition of the user 920 according to the structure indicated in FIG. 7. This structure may improve the quality of human health care or allow the health care takers to give the user a proper and instant medical treatment. The invention may also cope with a remotely control network system of an e-clinic or e-hospital to do a screening or checkup. With this system, physicians are able to gather information that is more concrete, and thus to carry out proper clinical decisions. E-clinic will definitely improve the quality of medical treatment that a patient may receive. The healthcare system illustrated in FIG. 7 will have a remarkable and eminent effect on elderly people, people who live in remote areas, people who are chronically ill, and people who need immediate medical treatment.

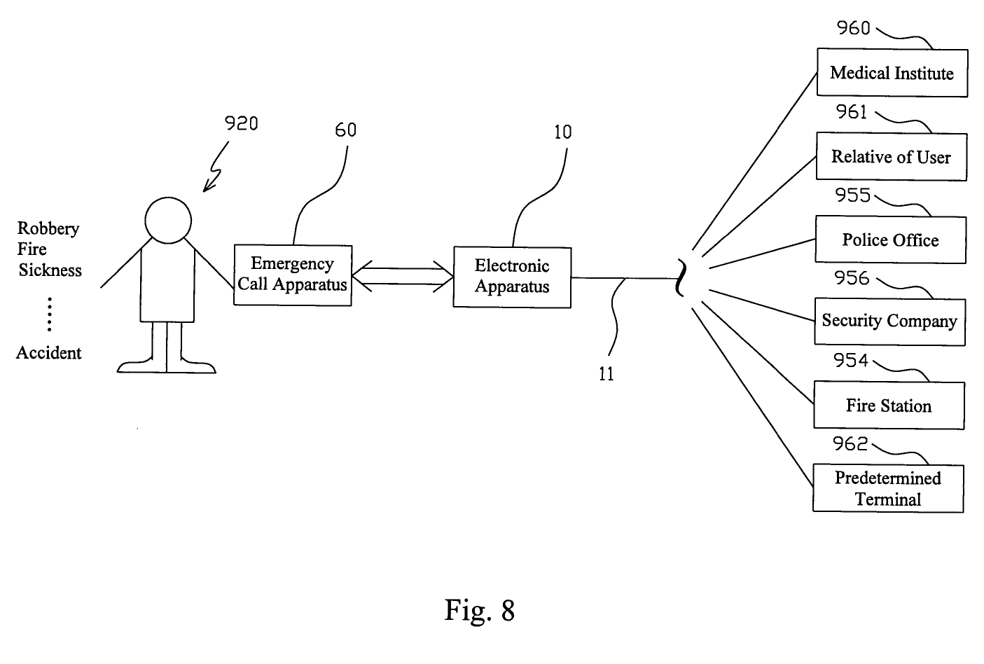

FIG. 8 illustrates a system structure for an emergency calling and alarming system. This system allows the users 920 to call for help in case of an emergency. As the figure has indicated, the users 920 may use an emergency call apparatus 60 to communicate with the electronic apparatus 10 in a unidirectional or bi-directional fashion. When emergency (such as robbery, fire) arises or the user suffers from any discomfort (for instance, carbon monoxide poisoning), (s)he may use this emergency calling and alarming system 60 to call for help, by sending an alarmed message to the electronic apparatus 10. The electronic apparatus will forward the message to a predetermined terminal, for example, an medical institute 960, fire department 954, police office 955, security company 956, friends and family (of the user) 961, or other predetermined terminal 962. This way the user will receive an immediate attention. The emergency call apparatus 60 may be a portable apparatus. For instance, a electronic watch, pager, mobile telephone, remote control apparatus, or any portable and easy-to-carry apparatus to is able to send out alarmed signal to the electronic apparatus 10. A better portable apparatus of this is equipped with an emergency call button. Therefore, when emergency arises, a user presses the call button to call for help. This will trigger the electronic apparatus 10 and the electronic apparatus will notify the predetermined terminal(s) immediately. Such emergency call apparatus may be a fixed terminal installed in a specific location, for instance, install an emergency call button next to the bed, or install an emergency call button or a pull-string in a bathroom. When these emergency call apparatus are being triggered or activated, they will send out an alarmed message to the electronic apparatus 10 and the electronic apparatus will pass out the message to alarm the relevant terminal or person. According to this embodiment, the emergency call apparatus 60 may communicate with the electronic apparatus 10 through a wired or wireless transmission medium such as RF, IR, a power line, telephone line or signal transmission line.

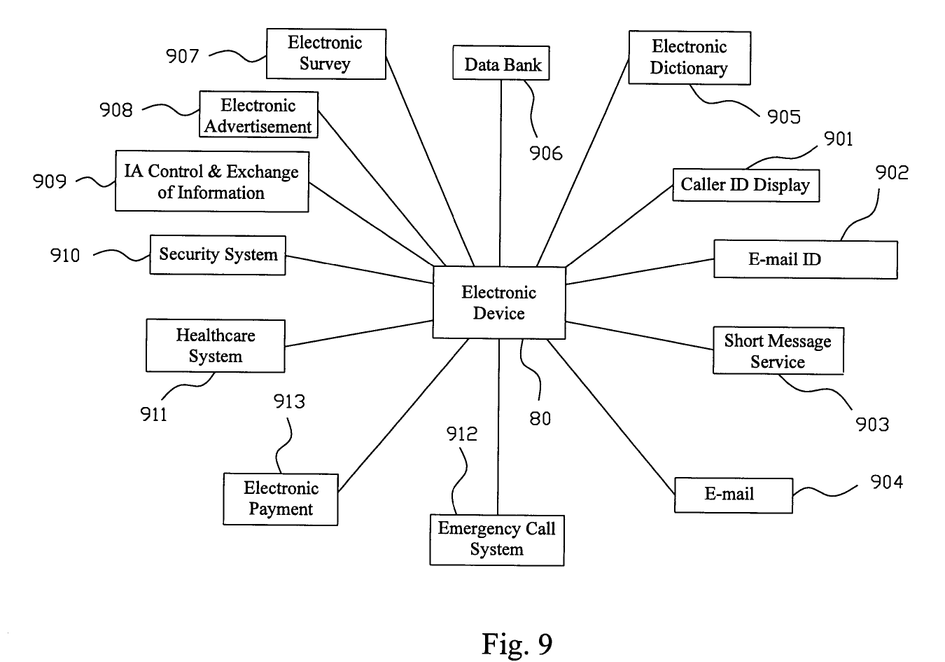

FIG. 9 illustrates the integrated system of the invention, wherein an electronic apparatus is integrated into a TV set. This allows and offers more capabilities to users besides its exiting entertaining capability. Many embodiments as described previously have already employed a TV screen to display data. The internal body of the electronic apparatus of the invention is not complicated. Therefore, with no doubt, an integrated TV is able to provide every capability and service as indicated in FIG. 1. The integrated TV 80 (as shown in FIG. 9) is not just a simple home entertainment appliance; it is now an information exchange center that integrates and provides multi-functionality and services. As demonstrated in the FIGS. 1 and 9, life may become easier and simpler because people have more power over their home appliances and the home appliances now offer greater capabilities than before. The price for the electronic apparatus (described in the invention) is not costly. Compare this integrated system to a conventional, independent and individual system, the invention greatly improve the system's performance. A TV set is a good example used to illustrate the invention. However, other apparatus (such as computer) may apply here as well.

E-payment mechanism may be carried out by equipping the TV set 80 with an electronic apparatus 10 (for example, a reader or reader). After the reader (for instance, a credit card reader) has processed the information and the status has got approved, it links to a money collecting center through a telephone line. Thus, (card) users may make their purchases (such as TV shopping] or computer game software) and these purchases may charge to their account. Such fee collecting mechanism saves people more time and it is very convenient.

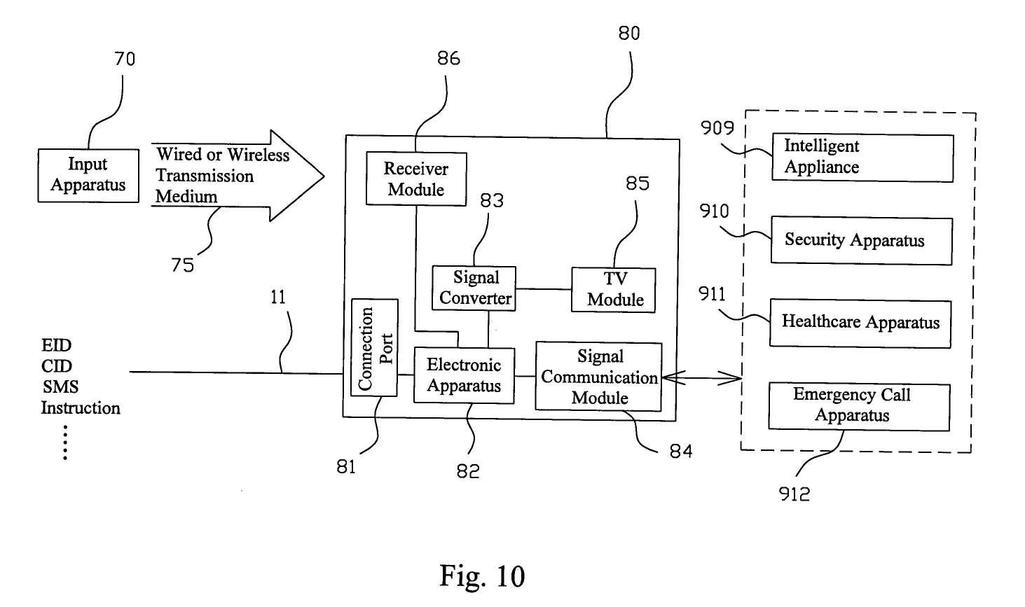

FIG. 10 further elaborates on the capability of the previous embodiment, TV 80, shown in FIG. 9. According to the invention, the TV set 80 consists of a connection port 81, electronic apparatus 82, signal format converter 83, and signal communication module 84. See FIG. 2 and all relevant information for the function and component of the electronic apparatus 82. The electronic apparatus 82 comprises a memory, which stores data (such as a word bank), and computer programs (application and utility). The electronic apparatus 82 links to a data-receiver module 86 (which is inside the TV set 80), connection port 81, signal format converter 83, and signal communication module 84 respectively. The signal format converter 83 and a TV module 85 are connected together; this linkage lets the decoded signal (which is processed by the electronic apparatus 82) display on the TV screen 80 or be voice output. The aforementioned signal format converter 83 converts the electronic apparatus 82's signal into an acceptable TV signal format. The output signal of the signal converter 83 is processed by the TV module 85 and then displayed on the screen of TV 80. Information on signal format converter 83, TV module 85, and signal conversion process is very well known to people who are in TV technology industry. Thus, no further details will be described here. The signal communication module 84 conducts one-way or two-way communication with home systems (for instance, intelligent appliance or security system). This one-way or two-way communication requires a corresponding signal communication module. Communications between the TV set 80 and other home appliances or facility in the house may be by a wired transmission medium (such as a teletelephone line, power line or signal transmission line) or a wireless transmission medium (such as IR or RF). The connection port 81 provides a gateway for connecting to a telephone line.

The transmitted signal from the telephone line 11 is transferred to the electronic apparatus 82 through the connection port 81; this signal may be data (such as CID, short messages, EID) or a instruction. The electronic apparatus 82 decodes the signal, and then transfers it to the signal format converter 83 or the signal communication module 84. For example, when the content of the transmitted signal through the telephone line 11 is data (for example, CID, short messages or EID) or a instruction (for TV set 80), the electronic apparatus 82 sends the decoded, transmitted signal (which is decoded by the signal format converter 83) to the TV set 80's TV module 85, and then the TV 80 will picture output (displaying on the TV screen) or voice output the content of the transmitted message, or act upon the signal's instruction. According to the structure, CID, SMS, and EID capabilities may thus be implemented.

In another embodiment, the transmitted signal from the telephone line 11 is a control instruction, which controls specific appliances or exchanges information with them. The instruction is transferred to the electronic apparatus 82 through the connection port 81 and the electronic apparatus sends out the instruction (after has been processed) to the address of the destination. If the address of the destination is the TV set 80, the instruction is first sent to the signal format converter 83, then transferred to the TV module 85. If the address of the destination is any other home appliances or systems, for instance, home intelligent appliances or security systems, the instruction is first sent to the signal format converter 83, then transferred to its corresponding appliance or system. These appliances or systems may also send signal back and communicate with the signal communication module.

User may use an input apparatus 70 to edit message or communicate other users through the TV set 80. After users finish editing, they send the edited messages to the electronic apparatus 82 for conversion, after that these messages are sent out through the telephone line 11, which is connected to the connection port. The input apparatus 70 has both editing and communicating capabilities. It is able to communicate with the TV receiver module 86. The input apparatus 70 may be a remote controller, mobile telephone, PDA, handwritten input apparatus, or keyboard. Communications between the input apparatus 70 and TV set 880 may be carried out by a wired or wireless transmission medium. Such transmission medium may be RF, IR or a transmission line.

Users may give instruction to their home appliances or systems (such as intelligent appliances or security systems) by the input apparatus 70. Such instruction may be used to control the appliances or systems, or to communicate and exchange information with them. The electronic apparatus 82 will first decode and convert the instruction, then send to the corresponding appliances or systems through the signal communication module 84. These appliances or systems may also transmit signal to the signal communication module 84.

Consider other possible communication situations. Home appliances or systems (for example, intelligent appliances or security systems) may accept a instruction from the TV set 80; this instruction is then sent to the signal communication module 84, after the instruction signal is converted, it is sent to the electronic apparatus 82. The content of the signal may include the address of the destination (such as the input apparatus 70 or a remotely contact terminal) or other default setting of predetermined terminal. The electronic apparatus 82 sends out the signal to its corresponding address of the destination, for instance, TV set 80. The electronic apparatus 82 sends the signal out to the signal format converter 83 and the converter will convert the signal. After that, the signal is sent to the TV module 85. If the address of the destination is a remotely contact terminal, the electronic apparatus 82 will send out the signal through a telephone line, which is connected to the connection port 82.

Different combination of integration is viable. Regarding to other embodiments, a TV receiver module 86 may integrate with the signal communication module 84 and the signal format converter 83 may integrate with the electronic apparatus 82.

The aforementioned home appliances may include an intelligent air-conditioner, intelligent refrigerator, and many other intelligent appliances, and the aforementioned home systems may include an emergency call system and a healthcare system as well as the security system. Although the detailed description of the invention has been directed to certain embodiments, various modifications of these embodiments, as well as alternative embodiments, will be suggested to those skilled in the art.

In other embodiments, a TV set 80 may accept voice output instruction. That is, a TV receiver module 85 contains a voice recognition apparatus. With this voice recognition capability, a user's voice is able to be converted into data or instruction.

One must notice that, according to the invention, transmission (of messages or instructions) and communication described here (for a household) are carried out by a household telephone line. With current mature call waiting technology, transmission of messages or instructions will not be affected even a household telephone line is occupied. However, transmission medium for transmitting messages or instructions from a household to a remote location (or vice versa) is not limited to telephone line. A transmission medium may be wireless medium or fiber optics cables.

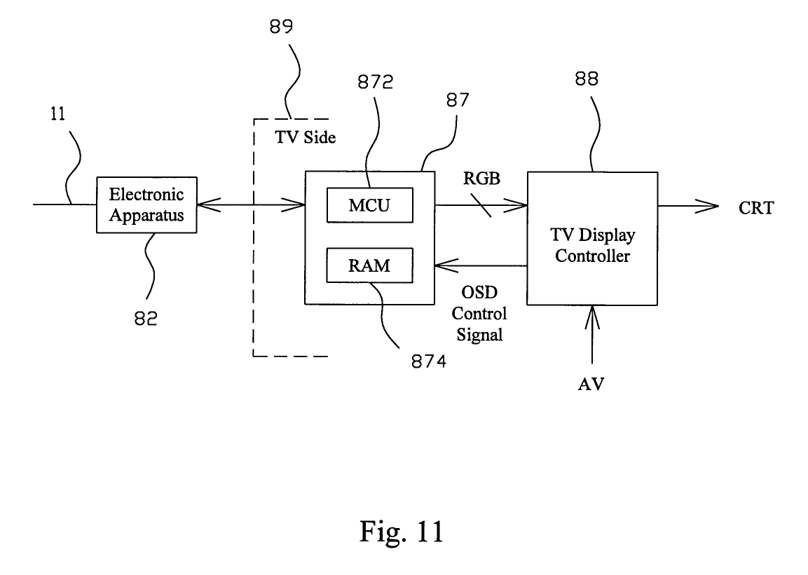

FIG. 11 illustrates another embodiment of incorporating the electronic apparatus into a TV set in accordance with the invention. Inside the apparatus, a TV-display controller 88 receives an AV signal and displays the content on the CRT screen, just like any other TV set does. The transmitted signal, which is sent to the electronic apparatus 82 through the telephone line 11, may be data (such as CID, SM, EID) or instructions. The electronic apparatus 82 decodes the signal and sends the signal to an on-screen display (OSD) data processor 87. An OSD data processor consists of MCU 872 and RAM 874. The OSD data processor is controlled by the TV-display control apparatus, particularly, by the apparatus's OSD control signal. The mechanism behind this is the electronic apparatus 82 sends data to the OSD data processor, based these data the OSD data processor generates an RGB signal and passes it to the TV-display control apparatus 88, then the TV-display control apparatus displays the content of the signal/message on TV CRT screen by running marquee for instance. FIG. 11 illustrates the make-up of a TV and labels it as a TV side 89 for the convenience of understanding the operation.

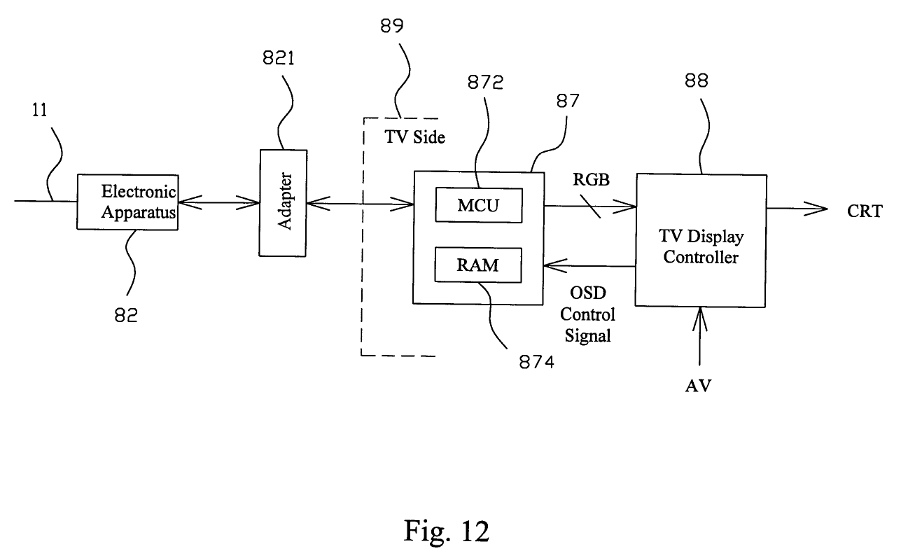

FIG. 12 illustrates another embodiment of incorporating the electronic apparatus into a TV set in accordance with the invention. The allocation of apparatus shown in FIG. 12 are the same as those shown in FIG. 11 except adding a signal format converter 87 in-between the electronic apparatus 82 and the OSD data processor 87. The signal format converter converts the output signal of the electronic apparatus 82 into a proper signal format and then send it to the OSD data processor. Thus, the electronic apparatus 82 may be now integrated into the TV set 89.

From the foregoing illustrations, we see capability improvements in the conventional Caller ID apparatus. The simple CID capability is expanded with SMS and EID capabilities incorporating into it. With assistance of a TV set or computer or any household appliances, the aforementioned information service (such as CID, SMS, or EID) becomes more convenient and easier for users when they are accessing them. Users may instantly attain real-time information with easy access at low cost. The aforementioned electronic apparatus (which provide information service) include an encoding mechanism that permits two-way communication. Two-way communication further provides many more functions for users. The examples of the enhanced capabilities are as the foregoing control (of intelligent appliances) and information exchange, security system, emergency call system, and healthcare system. The technological idea or concept of the invention as well as its application has not yet disclosed in the skilled art. Furthermore, the invention offers many more integrated information service and system capabilities. That certainly makes eminent improvements. Therefore, the design of invention conforms with the patent law and regulations.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An electronic apparatus comprising:
at least one codec for decoding a signal transmitted from
a telephone line, said transmitted signal having a destination address corresponding to a phone number designated by said telephone line;
a control circuit connected to said codec for controlling an operation flow of said electronic apparatus; and
a communication interface connected to said control circuit for communicating with outside.

2. The electronic apparatus of claim 1, wherein said signal has a content selected from the group consisted of CID, EID, e-mail, short message, e-survey, e-advertisement, weather report, traffic transportation time table, stock information, e-lottery, traffic status, and entertainment information.

3. The electronic apparatus of claim 1, wherein said codec is selected from the group consisted of FSK, DTMF and CAS codecs.

4. The electronic apparatus of claim 1, further comprising a display driver connected to said control circuit for driving a display.

5. The electronic apparatus of claim 4, wherein said display is selected from the group consisted of CRT, LED, LCD and PDP display.

6. The electronic apparatus of claim 4, wherein said display is provided by a TV or computer.

7. The electronic apparatus of claim 1, further comprising an alert output apparatus connected to said control circuit for notifying a new message arrived.

8. The electronic apparatus of claim 1, further comprising a voice output apparatus connected to said control circuit for reading out a message recovered by said codec.

9. The electronic apparatus of claim 1, further comprising a memory connected to said control circuit.

10. The electronic apparatus of claim 9, wherein said memory stores a content including a data and/or application program, said data is selected from the group consisted of dictionary, address book, calendar, financial information, e-book, and user-predetermined information.

11. The electronic apparatus of claim 10, wherein said user-predetermined information includes a predetermined terminal for receiving a message, said terminal is selected from the group consisted of medical institute, fire station, security company, police office, friend and/or family of a user, and other user-predetermined terminals.

12. The electronic apparatus of claim 1, wherein said communication interface communicates with an input apparatus by a wired or wireless transmission medium.

13. The electronic apparatus of claim 12, wherein said input apparatus is selected from the group consisted of remote controller, mobile telephone, pager, electronic watch, handwritten input apparatus, keyboard and PDA.

14. The electronic apparatus of claim 12, wherein said transmission medium is selected from the group consisted of power line, telephone line, RF and IR.

15. The electronic apparatus of claim 1, wherein said communication interface further communicates with an intelligent appliance in one-way or two-way manner by a wired or wireless transmission medium.

16. The electronic apparatus of claim 15, wherein said transmission medium is selected from the group consisted of power line, telephone line, RF and IR.

17. The electronic apparatus of claim 15, wherein said intelligent appliance is selected from the group consisted of an air conditioner, VCR, coffee maker, washing machine, electromagnetic stove, microwave oven, refrigerator, VCD player, DVD player and SVCD player.

18. The electronic apparatus of claim 1, wherein said communication interface is further connected to a security apparatus by a wired or wireless transmission medium for implementing a security system.

19. The electronic apparatus of claim 18, wherein said security apparatus is selected from the group consisted of sensor, fire alarm and monitoring system.

20. The electronic apparatus of claim 18, wherein said transmission medium is selected from the group consisted of power line, telephone line, RF and IR.

21. The electronic apparatus of claim 1, wherein said communication interface communicates with a healthcare apparatus by a wired or wireless transmission medium for performin a healthcare function.

22. The electronic apparatus of claim 19, wherein said healthcare apparatus is selected from the group consisted of sphygmomanometer, heart-rate measuring apparatus, glucometer, heart diagnostic apparatus and other health test apparatus.

23. The electronic apparatus of claim 21, wherein said transmission medium is selected from the group consisted of power line, telephone line, RF and IR.

24. The electronic apparatus of claim 1, wherein said communication interface communicates with an emergency call apparatus by a wired or wireless transmission medium for performing an emergency call function.

25. The electronic apparatus of claim 24, wherein said emergency call apparatus includes a button for instantly sending a message to said communication interface.

26. The electronic apparatus of claim 24, wherein said emergency call apparatus is a portable apparatus.

27. The electronic apparatus of claim 24, wherein said emergency call apparatus is an emergency call service terminal installed at a particular location.

28. The electronic apparatus of claim 26, wherein said portable apparatus is selected from the group consisted of mobile telephone, pager, electronic watch and remote controller.

29. The electronic apparatus of claim 24, wherein said transmission mediums is selected from the group consisted of power line, telephone line, RF, IR and signal transmission line.

30. The electronic apparatus of claim 1, further comprising a reader for proceeding an e-payment mechanism.

31. The electronic apparatus of claim 30, wherein said reader is a card reader.

32. A TV set comprising the electronic apparatus of claim 1.

33. An electronic apparatus for communicating with an intelligent appliance, comprising:
at least one decoder for decoding an instruction transmitted from a telephone line corresponding to a phone number, said instruction being transmitted to control said intelligent appliance or exchange an information; and
a control circuit connected to said decoder for controlling an operation flow of said electronic apparatus for said instruction to control said intelligent appliance or exchange an information.

34. The electronic apparatus of claim 33, further comprising a communication interface connected to said control circuit for transmitting said instruction to said intelligent appliance in various signal formats or receiving a signal from said intelligent appliance.

35. The electronic apparatus of claim 33, wherein said decoder is selected from the group consisted of FSK, DTMF and CAS decoders.

36. The electronic apparatus of claim 33, further comprising an encoder connected to said control circuit.

37. The electronic apparatus of claim 36, wherein said encoder is selected from the group consisted of FSK, DTMF and CAS encoders.

38. The electronic apparatus of claim 33, further comprising a display driver connected to said control circuit for driving a display.

39. The electronic apparatus of claim 38, wherein said display is selected from the group consisted of CRT, LED, LCD and PDP display.

40. The electronic apparatus of claim 38, wherein said display is provided by a TV or computer.

41. The electronic apparatus of claim 34, further comprising an alert output apparatus connected to said control circuit for notifying said instruction arrived.

42. The electronic apparatus of claim 34, wherein said communication interface communicates with outside by a wired or wireless transmission medium.

43. The electronic apparatus of claim 42, wherein said transmission medium is selected from the group consisted of power line, telephone line, RF and IR.

44. The electronic apparatus of claim 33, wherein said intelligent appliance is selected from the group consisted of air conditioner, VCR, coffee maker, washing machine, electromagnetic stove, microwave oven, refrigerator, VCD player, DVD player and SVCD player.

45. An intelligent appliance characterized in that said intelligent appliance includes an intelligent appliance for receiving an instruction transmitted from a teletelephone network, said transmitted instruction having a destination address corresponding to a phone number designated by said intelligent appliance, said intelligent appliance comprising:
at least one decoder for decoding said instruction, said instruction being transmitted to control said intelligent appliance or exchange an information; and
a control circuit connected to said decoder for controlling an operation flow of said electronic apparatus for said instruction to control said intelligent appliance or exchange an information.

46. The intelligent appliance of claim 45, wherein said electronic apparatus further comprises a communication interface connected to said control circuit for communicating with outside in one-way or two-way manner.

47. The intelligent appliance of claim 45, wherein said decoder is selected from the group consisted of FSK, DTMF and CAS decoders.

48. The intelligent appliance of claim 45, further comprising an encoder connected to said control circuit.

49. The intelligent appliance of claim 48, wherein said encoder is selected from the group consisted of FSK, DTMF and CAS encoders.

50. The intelligent appliance of claim 45, further comprising an alert output apparatus connected to said control circuit for notifying said instruction arrived.

51. The intelligent appliance of claim 45, wherein said communication interface communicates with outside in one-way or two-way manner by a wired or wireless transmission medium.

52. The intelligent appliance of claim 45, wherein said transmission medium is selected from the group consisted of power line, telephone line, RF and IR.

53. The intelligent appliance of claim 45, wherein said intelligent appliance is selected from the group consisted of air conditioner, VCR, coffee maker, washing machine, electromagnetic stove, microwave oven, refrigerator, VCD player, DVD player and SVCD player.

54. The intelligent appliance of claim 45, wherein said phone number includes an extension number or a code.

55. A method for controlling an intelligent appliance having a decoder for decoding an instruction transmitted from a telephone network to operate said intelligent appliance, said method comprising the steps of:
corresponding said intelligent appliance to a phone number; and
transmitting said instruction to control said intelligent appliance, said transmitted instruction having a destination address corresponding to said phone number.

56. The method of claim 55, wherein said intelligent appliance is selected from the group consisted of air conditioner, VCR, coffee maker, washing machine, electromagnetic stove, microwave oven, refrigerator, VCD player, DVD player and SVCD player.

57. The method of claim 55, wherein said instruction is edited on an internet.

58. The method of claim 55, wherein said instruction is edited by a user on a website.

59. The method of claim 55, wherein said website is provided by an appliance supplier.

60. The method of claim 55, wherein said phone number includes an extension number or a code.

61. The method of claim 55, further comprising feeding back by said intelligent appliance based on a source and content of said instruction.

62. A method for a server for generating a control instruction for an intelligent appliance, comprising the steps of:
providing a menu for a user to select an intelligent appliance to control and an operation to proceed;
generating a control instruction based on an input by said user at the previous step;
assigning a phone number configured by said user to be a destination address to receive said control instruction; and
transmitting said control instruction to said phone number side.

63. The method of claim 62, wherein said server is provided by an appliance supplier.

64. The method of claim 62, wherein said user connects an input apparatus to said server by an internet.

65. The method of claim 64, wherein said input apparatus is selected from the group consisted of computer, PDA, handwritten input apparatus and mobile telephone.

66. The method of claim 62, wherein said phone number includes an extension number or a code.

67. An intelligent appliance control system implemented on a telephone network, comprising:
an electronic apparatus corresponding to a phone number;
an instruction source for transmitting a control instruction to said electronic apparatus through said telephone network for controlling said intelligent appliance, said control instruction having a destination address corresponding to said phone number; and
at least one intelligent appliance communicating with said electronic apparatus;
wherein said electronic apparatus comprises:
at least one decoder for decoding said control instruction; and
a control circuit connected to said decoder for controlling an operation flow of said electronic apparatus for said recovered control instruction to control said intelligent appliance.

68. The system of claim 67, wherein said decoder is selected from the group consisted of FSK, DTMF and CAS decoders.

69. The system of claim 67, further comprising an encoder connected to said control circuit.

70. The system of claim 69, wherein said encoder is selected from the group consisted of FSK, DTMF and CAS encoders.

71. The system of claim 67, further comprising an alert output apparatus connected to said control circuit for notifying said instruction arrived.

72. The system of claim 67, wherein said electronic apparatus further comprises a communication interface connected to said control circuit for communicating with outside in one-way or two-way manner.

73. The system of claim 72, wherein said communication interface communicates with outside by a wired or wireless transmission medium.

74. The system of claim 72, wherein said communication interface receives an instruction from an input apparatus by a wired or wireless transmission medium.

75. The system of claim 74, wherein said input apparatus is selected from the group consisted of remote controller, mobile telephone, pager, electronic watch, handwritten input apparatus, keyboard and PDA.

76. The system of claim 73 or 74, wherein said transmission medium is selected from the group consisted of power line, telephone line, RF and IR.

77. The system of claim 67, wherein said intelligent appliance is selected from the group consisted of air conditioner, VCR, coffee maker, washing machine, electromagnetic stove, microwave oven, refrigerator, VCD player, DVD player and SVCD player.

78. The system of claim 67, wherein said electronic apparatus is integrated in said intelligent appliance.

79. The system of claim 67, wherein said instruction source is selected from the group consisted of mobile telephone, PDA, computer and website.

80. The system of claim 79, wherein said website is provided by an appliance supplier.

81. The system of claim 67, wherein said phone number includes an extension number or a code.

82. A security system implemented on a teletelephone network, comprising:
at least one monitoring apparatus for monitoring an environment; and
an electronic apparatus for communicating with a telephone line corresponding to a phone number, said electronic apparatus communicating with said monitoring apparatus by a wired or wireless transmission medium, said electronic apparatus comprising:
a signal format converter for converting a signal transmitted from said monitoring apparatus to a format for transmission on said telephone line; and
a control circuit connected to said signal format converter for controlling an operation flow of said electronic apparatus to transmit said signal from said monitoring apparatus to a predetermined terminal by said telephone line.

83. The security system of claim 82, wherein said signal format converter is selected from the group consisted of FSK, DTMF and CAS codecs.

84. The security system of claim 82, wherein said predetermined terminal is selected from the group consisted of medical institute, fire station, security company, police office, friend and/or family of a user, and other predetermined terminal.

85. The security system of claim 82, wherein said electronic apparatus further comprises a communication interface connected to said control circuit for communicating with outside in one-way or two-way manner.

86. The security system of claim 85, wherein said communication interface communicates with an input apparatus by a wired or wireless transmission medium.

87. The security system of claim 86, wherein said input apparatus is selected from the group consisted of remote controller, mobile telephone, pager, electronic watch, keyboard, handwritten input apparatus and PDA.

88. The security system of claim 82 or 86, wherein said transmission medium is selected from the group consisted of power line, telephone line, RF and IR.

89. The security system of claim 82, wherein said monitoring apparatus is selected from the group consisted of sensor, fire alarm, and monitoring system.

90. An electronic apparatus for a security system, said electronic apparatus corresponding to a phone number, said security system including at least one monitoring apparatus for monitoring an environment and communicating with said electronic apparatus by a wired or wireless transmission medium, said electronic apparatus comprising:
a signal format converter for converting a signal transmitted from said monitoring apparatus to a format for transmission on a telephone line; and
a control circuit connected to said signal format converter for controlling an operation flow of said electronic apparatus to transmit said signal from said monitoring apparatus to a predetermined terminal by said telephone line.

91. The electronic apparatus of claim 90, wherein said signal format converter is selected from the group consisted of FSK, DTMF and CAS codecs.

92. The electronic apparatus of claim 90, wherein said predetermined terminal is selected from the group consisted of medical institute, fire station, security company, police office, friends and family of a user, and other predetermined terminals.

93. The electronic apparatus of claim 90, further comprising a communication interface connected to said control circuit for communicating with outside in one-way or two-way manner.

94. The electronic apparatus of claim 93, wherein said communication interface communicates with an input apparatus by a wired or wireless transmission medium.

95. The electronic apparatus of claim 94, wherein said input apparatus is selected from the group consisted of remote controller, mobile telephone, pager, electronic watch, keyboard, handwritten input apparatus and PDA.

96. The electronic apparatus of claim 90 or 94, wherein said transmission medium is selected from the group consisted of power line, telephone line, RF and IR.

97. The electronic apparatus of claim 90, wherein said monitoring apparatus is selected from the group consisted of sensor, fire alarm and monitoring system.

98. The electronic apparatus of claim 90, wherein said phone number includes an extension number or a code.

99. A monitoring apparatus for monitoring an environment, characterized in that said monitoring apparatus is built-in with an electronic apparatus comprising:
at least one signal format converter for converting a signal transmitted from said monitoring apparatus to a format for transmission on a telephone line; and
a control circuit connected to said signal format converter for controlling an operation flow of said electronic apparatus to transmit said signal from said monitoring apparatus to a predetermined terminal by said telephone line corresponding to a phone number.

100. The monitoring apparatus of claim 99, wherein said signal format converter is selected from the group consisted of FSK, DTMF and CAS codecs.

101. The monitoring apparatus of claim 99, wherein said predetermined terminal is selected from the group consisted of medical institute, fire station, security company, police office, friends and family of a user, and other predetermined terminals.

102. The monitoring apparatus of claim 99, wherein said electronic apparatus further comprises a communication interface connected to said control circuit for communicating with outside in one-way or two-way manner.

103. The monitoring apparatus of claim 99, wherein said communication interface communicates with an input apparatus by a wired or wireless transmission medium.

104. The monitoring apparatus of claim 103, wherein said input apparatus is selected from the group consisted of remote controller, mobile telephone, pager, electronic watch, keyboard, handwritten input apparatus and PDA.

105. The monitoring apparatus of claim 102 or 103, wherein said transmission medium is selected from the group consisted of power line, telephone line, signal transmission line, RF and IR.

106. The monitoring apparatus of claim 99, wherein said monitoring apparatus is selected from the group consisted of sensor, fire alarm and monitoring system.

107. A healthcare system comprising:
a healthcare apparatus;
at least one communication terminal;
an electronic apparatus connected to a telephone line corresponding to a phone number, said electronic apparatus communicating with said healthcare apparatus by a wired or wireless transmission medium and with said communication terminal by said telephone line, said healthcare apparatus and communication terminal transmitting data to each other through said electronic apparatus, said electronic apparatus comprising:
a signal format converter for converting a signal transmitted from said healthcare apparatus and communication terminal; and
a control circuit connected to said signal format converter for controlling an operation flow of said electronic apparatus;
wherein said communication terminal transmits a signal to said electronic apparatus by assigning said phone number to be a destination address.

108. The system of claim 107, wherein said phone number includes an extension number or a code.

109. The system of claim 107, further comprising a display connected to said electronic apparatus for said electronic apparatus to transmit a signal from said communication terminal to said display.

110. The system of claim 107, wherein said signal format converter is selected from the group consisted of FSK, DTMF and CAS codecs.

111. The system of claim 109, wherein said electronic apparatus further comprises a display driver connected to said control circuit for driving said display.

112. The apparatus of claim 109, wherein said display is selected from the group consisted of CRT, LED, LCD and PDP display.

113. The system of claim 109, wherein said display is provided by a TV or computer.

114. The system of claim 107, wherein said electronic apparatus further comprises an alert output apparatus connected to said control circuit for notifying a new message arrived.

115. The system of claim 107, wherein said transmission medium is selected from the group consisted of power line, telephone line, RF and IR.

116. The system of claim 107, wherein said healthcare apparatus is selected from the group consisted of sphygmomanometer, heart-rate measuring apparatus, glucometer, heart diagnostic apparatus and other health test apparatus.

117. The system of claim 107, wherein said communication terminal is selected from the group consisted of medical institute, family doctor and/or relative of a user, and other predetermined terminals.

118. An electronic apparatus for healthcare service for transmitting a signal from a healthcare apparatus to a user-predetermined terminal by a telephone line, said electronic apparatus comprising:
a signal format converter for converting a signal transmitted from said healthcare apparatus to a format for transmission on said telephone line; and
a control circuit connected to said signal format converter for controlling an operation flow of said electronic apparatus.

119. The apparatus of claim 118, wherein said signal format converter is selected from the group consisted of FSK, DTMF and CAS codecs.

120. The apparatus of claim 118, wherein said electronic apparatus further comprises a display driver connected to said control circuit for driving a display.

121. The apparatus of claim 118, wherein said electronic apparatus further comprises an alert output apparatus for notifying a new message arrived.

122. The apparatus of claim 118, wherein said healthcare apparatus is selected from the group consisted of sphygmomanometer, heart-rate measuring apparatus, glucometer, heart diagnostic apparatus and other health test apparatus.

123. The apparatus of claim 118, wherein said communication terminal is selected from the group consisted of medical institute, family doctor and/or relative of a user, or other predetermined terminals.

124. A multi-functional TV set comprising:
a connection port for connecting to a telephone line corresponding to a phone number;
an electronic apparatus comprising:
at least one codec for decoding a signal transmitted from a telephone line, said transmitted signal having a destination address corresponding to said phone number;
a control circuit connected to said codec for controlling an operation flow of said electronic apparatus; and
a signal converter for converting said decoded signal to a TV signal; and
a TV module for outputting a content from said signal converter in picture and/or voice manner.

125. The TV set of claim 124, wherein said signal from said telephone line to said TV set has a content selected from the group consisted of CID, EID, e-mail, SMS, e-survey, e-advertisement, weather report, traffic transportation time table, stock information, e-lottery, traffic status and entertainment information.

126. The TV set of claim 124, wherein said signal converter is selected from the group consisted of FSK, DTMF and CAS codecs.

127. The TV set of claim 124, further comprising a memory connected to said control circuit.

128. The TV set of claim 127, wherein said memory stores a data and/or application program, said data having a content selected from the group consisted of dictionary, address book, calendar, financial information, e-book, and predetermined information.

129. The TV set of claim 124, wherein said electronic apparatus is connected to a receiver module for communicating with an external input apparatus by a wired or wireless transmission medium.

130. The TV set of claim 128, wherein said input apparatus is selected from the group consisted of remote controller, mobile telephone, pager, electronic watch, keyboard, handwritten input apparatus and PDA.

131. The TV set of claim 129, wherein said transmission medium is selected from the group consisted of power line, telephone line, signal transmission line, RF and IR.

132. The TV set of claim 124, further comprising a signal communication module connected to said electronic apparatus for communicating with outside in one-way or two-way manner.

133. The TV set of claim 132, wherein said signal communication module communicates with an intelligent appliance by a wired or wireless transmission medium for controlling said intelligent appliances or exchanging an information.

134. The TV set of claim 133, wherein said transmission medium is selected from the group consisted of power line, telephone line, signal transmission line, RF and IR.

135. The TV set of claim 133, wherein said intelligent appliance is selected from the group consisted of air conditioner, VCR, coffee maker, washing machine, electromagnetic stove, microwave oven, refrigerator, VCD player, DVD player and SVCD player.

136. The TV set of claim 132, wherein said signal communication module is further connected to a security apparatus by a wired or wireless transmission medium for implementing a security system.

137. The TV set of claim 136, wherein said security apparatus is selected from the group consisted of sensor, fire alarm and monitoring system.

138. The TV set of claim 136, wherein said transmission medium is selected from the group consisted of power line, telephone line, signal transmission line, RF and IR.

139. The TV set of claim 132, wherein said signal communication module communicates with a healthcare apparatus by a wired or wireless transmission medium.

140. The TV set of claim 139, wherein said healthcare apparatus is selected from the group consisted of sphygmomanometer, heart-rate measuring apparatus, glucometer, heart diagnostic apparatus and other health test apparatus.

141. The TV set of claim 139, wherein said transmission medium is selected from the group consisted of power line, telephone line, RF and IR.

142. The TV set of claim 132, wherein said signal communication module communicates with an emergency call apparatus by a wired or wireless transmission medium.

143. The TV set of claim 142, wherein said emergency call apparatus has a button for instantly sending out an emergency call to said signal communication module.

144. The TV set of claim 142, wherein said emergency call apparatus is a portable apparatus.

145. The TV set of claim 144, wherein said portable apparatus has a button for instantly sending out an emergency call to said signal communication module.

146. The TV set of claim 144, wherein said portable apparatus is selected from the group consisted of mobile telephone, pager, electronic watch, electronic button and remote controller.

147. The TV set of claim 142, wherein said emergency call apparatus is installed on an emergency call service terminal at a particular location.

148. The TV set of claim 142, wherein said transmission medium is selected from the group consisted of telephone line, power line, signal transmission line, RF and IR.

149. The TV set of claim 124, further comprising a reader for proceeding an e-payment mechanism.

150. The TV of claim 149, wherein said reader is a card reader.
